(19) United States
(12) Patent Application Publication
(10) Pub. No.: US 2010/0180202 A1
(43) Pub. Date: Jul. 15, 2010

(54) User Interfaces for Electronic Devices

(75) Inventor: Rafael Del Valle Lopez, Barcelona (ES)

Correspondence Address: HAYES, SOLOWAY P.C., 175 CANAL STREET, MANCHESTER, NH, 03101, US

(73) Assignee: VIDA SOFTWARE S.L., Barcelona (ES)

(21) Appl. No.: 11/993,589

(22) PCT Filed: Jul. 5, 2006
(86) PCT No.: PCT/GB2006/002486

§ 371 Date: Feb. 25, 2010

(30) Foreign Application Priority Data
Jul. 5, 2005 (GB) 0513786.4

(51) Int. Cl. G06F 3/048; G06F 3/16

(52) U.S. Cl. 715/728; 715/771

(57) ABSTRACT

A mobile telephone (1) includes a multimodal user interface and a rendering unit (10) that can be used to display icons on the display screen (3) of the mobile telephone (1). The rendering unit (10) receives inputs from a number of status factor determiners of the mobile telephone (1), such as an environmental quality assessment unit (7), a data quality of service unit (8), a network signal strength unit (9), an application engine (5), multimodal interface components (11), and an automatic speech recognition unit of a speech engine (22). The rendering unit (10) uses the status information that it receives to select an icon to be displayed to convey information about the current status of the mobile telephone (1) to the user. The icon that is displayed by the rendering unit (10) is in the form of a human face that can show varying expressions and emotions.

The present invention relates to the provision and operation of user interfaces for electronic devices and in particular to user interfaces for portable or mobile devices, such as mobile telephones, personal digital assistants (PDAs), tablet PCs, in-car navigation and control systems, etc.

Electronic devices, such as mobile telephones, will typically include a so-called “user interface”, to allow a user to control the device and, e.g., input information and control commands to the device, and/or receive information from the device.

For example, a mobile device such as a telephone will typically include a screen or display for providing information to a user and a key pad for allowing a user to input commands, etc., to the device. It is also known to provide electronic devices with a so-called “speech-enabled” user interface, whereby a user may control the device using voice (spoken) commands, and the device may provide information to the user in the form of spoken text. A user interface that offers plural different input and output modes, such as a screen, keypad and speech, is commonly referred to, as is known in the art, as a “multimodal” user interface (since it provides multiple modes of user interface operation).

One typical aspect of user interface operation, particularly in the context of portable communications devices, is the provision of information to a user relating to the status of the device and/or its current condition or operation, etc. For example, it may be desirable to indicate to a user the strength of the communications signal currently being received, the status of a packet network, whether the device has activated its resources or connected to a communications network, etc., and/or the state of charge of a battery of the device, etc. In the case of a speech-enabled interface, it may be desirable to provide feedback to the user as to whether the device can detect (hear) and/or understand or recognise the user's spoken commands.

As is known in the art, such status information, etc., can be and indeed, typically is, provided to a user in the form of icons on a display of the device.

However, the Applicants have recognised that existing arrangements for such display can have disadvantages. For example, the relatively small and constrained size of display available on typical portable devices such as mobile phones can limit the size and number of status icons that can be displayed. It can also accordingly be difficult for a user to properly assess and understand multiple icons that may be displayed simultaneously on the device's display. This problem can be exacerbated where the device is being used in a more difficult environment (such as outdoors or in a vehicle), as is commonly the case for portable devices.

The Applicants believe therefore that there remains scope for improvement to the display of status information to users of electronic devices, and in particular portable electronic devices.

According to a first aspect of the present invention, there is provided a method of providing status information to a user of an electronic device, the method comprising:

displaying on a display of the electronic device an icon representing the status of two or more factors relating to the operation or condition of the device.

According to a second aspect of the present invention, there is provided an apparatus or system for providing a user interface for an electronic device, comprising:

means for displaying on a display of the electronic device an icon representing the status of two or more factors relating to the operation or condition of the device.

According to a third aspect of the present invention, there is provided an electronic device, comprising:

a display; and

means for displaying on the display an icon representing the status of two or more factors relating to the operation or condition of the device.

In the present invention, an icon is displayed on a display of an electronic device to give a user information relating to the status or condition of the device, as in prior art systems. However, the icon that is displayed represents the status of two or more factors relating to the condition of the device. In other words, a single icon is used to convey information regarding plural factors relating to the status or condition or operation of the device. The Applicants believe that using a single icon in this manner is preferable and easier for a user to understand, as compared, e.g., to using multiple icons, one for each status factor, particularly for electronic devices where the display size or quality (e.g. resolution) may be constrained.

The factors relating to the status or condition of the device that are conveyed via the icon can be selected as desired and can, e.g., (and, indeed, preferably do) relate to such factors that it is already known to provide status information on.

Thus they could, for example, and indeed preferably do, relate to the current condition of the device itself, such as the state of charge of a or the battery of the device, whether the device is “busy”, whether the device has activated or is still waiting to activate a resource or resources, and/or whether the device is operating correctly or has a malfunction, etc.

In the case of communications devices at least, factors whose status is displayed preferably also or instead include one or more of the status of the communications network, whether the device has or is connected to the network, the status of a communications signal being received or sent (e.g. its signal quality or level), the status of a packet network (e.g. whether there is network packet loss) to which the device is coupled, and/or whether a called party is available or can be called, etc.

In the case of devices that have a speech-enabled interface, factors whose status are displayed preferably also or instead include one or more of whether the device can detect (hear) a user's spoken commands, and/or whether the device can understand or recognise a user's spoken commands (this could be based, e.g., on a confidence value returned from the speech recognition engine), etc.

It would also be possible to display the status of other factors, such as environmental conditions, such as noise, etc. (e.g. relating to the current environment of the user, such as whether there is a lot of background noise (which may make speech recognition difficult), etc.).

In a preferred embodiment, the displayed status factors relate to the condition or status of one or more of: the user interface and user interaction with the device, the communications network or networks to which the device is coupled, and/or the underlying operation of the device and/or of applications that are running on it or being accessed by it.

The actual factors whose status is displayed in common using the icon can be selected as desired. The icon can preferably be used to convey the status of at least 3 factors.

In a preferred embodiment, the icon is used to display and represent the status of a plurality of factors that relate to or could affect the user's interaction, e.g. multi-modal interaction, with the device. Thus the icon preferably indicates, e.g., the status of a packet network to which the device is coupled (e.g. whether there is packet loss), whether the device can detect a user's spoken commands (e.g. whether the user's environment is noisy), and whether the device can recognise a user's spoken commands. The status of the packet network is or can be important in particular for speech-enabled interfaces where the speech processing is distributed over the communications network and device, as the necessary data exchange will then typically take place via a packet data network of the communications system.

In a particularly preferred embodiment, the icon can also convey an overall overview or impression of the status factors it relates, e.g., of the user interaction with the device, e.g., to convey to the user whether the overall, combined status is “good” or “bad”. Preferably the displayed icon conveys in real time to the user whether their interaction with the device is going well or badly.

In a particularly preferred embodiment, the icon can be used to display information relating to two or more of, and preferably all of, the following factors, preferably simultaneously (although this is not essential and indeed may be inappropriate where the factors are mutually exclusive or incompatible with each other): signal strength; connected or not connected to a communications network; audio and speech resources acquired or not; ambient noise and/or spoken voice quality; final and partial speech recognition acknowledgement; packet loss detection; user expertise empathy; and/or an application selected “mood”.

The icon that is displayed can convey the status of the plural factors to which it relates in any desired and suitable manner. For example, the size or shape of the icon could be used to convey status information about one factor, and the colour of the icon used to convey status information about a second factor. The background and/or overall appearance of the icon could also be and preferably is also used to convey information, for example by showing a “dirty” or distorted image to convey the presence of noise or a poor communications connection (signal), or by causing the icon to blink when data packets are lost. The different icon states or appearances that are used to convey the status of the factors to which the icon relates are preferably arranged such that they can be clearly or readily distinguished from each other.

The actual shape or nature of the icon can be selected as desired. Thus it could, for example, be a shape or symbol or image that a user would associate with the status factors in question, or it could be completely unrelated thereto. In a preferred embodiment, the size and/or resolution (detail) of the icon can be and preferably is varied in use. Most preferably, the icon can be presented both in a “normal” and “close-up” form, for example upon user-selection or automatically, e.g., in response to selected, e.g., predetermined events. The Applicants believe that such resizing of the icon may again help the conveyance of the desired status information to the user. Such resizing of the icon could be, e.g., controlled by an application of the device, and be, e.g., dependent on the current operation of device and/or the user's current interaction with it.

In a particularly preferred embodiment, the icon that is displayed can convey a range of values or status condition levels for a or more than one or all of the factors that it relates to. This may be useful for factors such as signal quality, noise level, speech command recognition or detection, etc., where the status of the factor can vary over a range of possible states or values. To achieve this, the icon could have, e.g., a range of shapes or sizes or colours, etc., which can be selected and used accordingly.

The actual icon that is displayed in response to the status of the factors in question can be selected as desired and in any suitable manner. For example, plural possible, predetermined icons could be stored and, e.g., associated with particular criteria, such as values for the status factors that the icon is to convey. The determined factors would then be used to select the icon to use accordingly.

In such an arrangement, each icon could, e.g., be associated with a particular value or threshold for the factor in question, or a range of values, and the current value of the factor or factors in question compared with these thresholds or ranges to determine the icon to use. The thresholds and ranges could, e.g., be fixed, or, e.g., be configurable and variable in use. They could also be (and indeed, preferably are) arranged to differ depending upon in which direction the value of the status factor in question is moving (i.e. whether it is increasing or decreasing). This would allow the introduction of some hysteresis into the icon threshold changes, thereby, e.g., avoiding unnecessarily frequent changes of icon around a threshold factor value.

Thus, in a particularly preferred embodiment, the method, system, apparatus or electronic device of the present invention stores or includes a means for storing a set or sets of icons that may be displayed in use (in accordance with the present invention).

In a particularly preferred embodiment, the status of a or the communications network to which the device is coupled is conveyed by visual changes or the appearance of the overall icon or image, preferably by adding signal “noise” to the image of the icon. Thus, the brightness of the icon is preferably used to convey the current strength or quality of the communications signal being sent from and/or received by the device (with a brighter image preferably indicating a stronger or better signal and vice-versa). Similarly, loss of data packets (where a packet data network is being used) is preferably conveyed by adding “noise” or “interference” to the image of the icon, i.e. by disturbing or distorting the image (e.g. to make it look as though it is not “tuned in” properly).

In a preferred embodiment, the icon can convey to a user whether the device or a resource or resources of the device are active or acquired or not, and/or, e.g., whether the device is yet to connect to a communications network. This is preferably done by showing the icon to be “absent”, e.g., by showing it in a faded or outline manner, or as a blinking or flashing display.

Where the device has a speech-enabled user interface, the icon can preferably convey an acknowledgement of a user's spoken words or commands. This could be given when or whenever a spoken command is recognised by the speech recognition engine of the device. The acknowledgement preferably comprises a temporary change to the displayed icon, e.g., by making it flash or flash brighter or change colour briefly.

In a particularly preferred such embodiment, the icon can be used to convey and give a visual acknowledgement of a user's spoken commands as the user is speaking (i.e. not just simply acknowledge a complete spoken command or sentence). Such “partial” acknowledgement as a user is speaking will help to encourage a user as they give spoken commands to the device, thereby encouraging them to interact with the device, and, e.g., use more complex spoken commands. Preferably an indication of whether the word or words spoken by the user thus far have been recognised and/or are likely (or not) to be part of a recognisable sentence or command is given after each word or after every two words or every few words spoken by the user.

Such partial acknowledgements could be achieved as desired. For example, a measure of how well or whether each word or set of words spoken by the user has been recognised could be determined and used to determine whether to give an acknowledgement and/or the form of acknowledgement to give.

In a particularly preferred such embodiment, a measure, such as a probability, of whether (or not) a word or set of words spoken by the user (such as the words spoken thus far by the user) is part of (e.g. the beginning of) a recognisable sentence or command is determined and used to determine whether to give an acknowledgement and/or the form of acknowledgement to give. In a preferred such arrangement, an initial, e.g. predetermined, probability measure (such as 50%) is set and then adjusted as the user speaks, with, e.g., a predetermined change in the probability value (e.g. it crossing a threshold) triggering an acknowledgement of some form.

In the above or other forms of these arrangements, each word or set of words could be identified in any desired manner, for example by identifying pauses in the user's speech. The probability that the word or words form part of a recognisable sentence or command could be determined, e.g., by using statistical analysis of extracted features from the audio wave of the user's speech, e.g. when compared to a phonetic dictionary, and/or, optionally, also or instead using speech recognition grammars that convey all possible recognisable sentences. Suitable such techniques are known in the art.

In a particularly preferred embodiment, a speech recognition engine is arranged to provide an interim or partial confidence measurement as the user is speaking (e.g. based on an assessment of what the user has said so far), preferably periodically as the user speaks (e.g., after each identified spoken word or at predetermined intervals while the user is speaking), which interim confidence measure is then used to determine whether and how to acknowledge the user's spoken words as they speak. For example, the interim confidence measure could be used to determine an icon to be displayed, or to determine whether and/or how to modify a displayed status icon.

Such an interim confidence measure returned by the speech recognition engine or unit should be contrasted with the final, overall confidence measure that the speech recognition unit will produce when it is determined that a user's spoken command has finished (e.g. by identifying a pause indicating the end of the speech, or some other positive, “end point” action, such as the user pressing or releasing a key or other input of the device). The interim or partial confidence measurement is provided (and used) whilst the user is speaking, and not just after some predetermined endpoint event has occurred or been detected.

It would, of course, still be possible in these arrangements to determine a final, overall confidence measure once the user has finished speaking and use that confidence measure to provide an overall acknowledgement (or not) for the whole sentence or command. Indeed, this is preferably done.

It is believed that the use of a speech recognition apparatus to provide an interim confidence measure as discussed above may be new and advantageous in its own right. Thus, according to a fourth aspect of the present invention, there is provided an apparatus or system for assessing commands spoken by a user to a speech-enabled user interface of an electronic device, comprising:

means for determining a measure of whether a user's spoken word or words to the device are likely to be part of a recognisable sentence or command;

means for determining when a user's spoken command has finished;

means for providing as an output parameter a determined measure of whether the user's spoken word or words to the device are likely to be part of a recognisable sentence or command when it is determined that the user's spoken command has finished; and

means for providing as an output parameter a determined measure of whether the user's spoken word or words to the device are likely to be part of a recognisable sentence or command before it is determined that the user's spoken command has finished.

According to a fifth aspect of the present invention, there is provided a method of operating an electronic device having a speech-enabled user interface, the method comprising:

determining a measure of whether a user's spoken word or words to the device are likely to be part of a recognisable sentence or command;

determining when a user's spoken command has finished;

providing as an output parameter a determined measure of whether the user's spoken word or words to the device are likely to be part of a recognisable sentence or command when it is determined that the user's spoken command has finished; and

providing as an output parameter a determined measure of whether the user's spoken word or words to the device are likely to be part of a recognisable sentence or command before it is determined that the user's spoken command has finished.

According to a sixth aspect of the present invention, there is provided an electronic device, comprising:

a speech-enabled user interface;

means for determining a measure of whether a user's spoken word or words to the device are likely to be part of a recognisable sentence or command;

means for determining when a user's spoken command has finished;

means for providing as an output parameter a determined measure of whether the user's spoken word or words to the device are likely to be part of a recognisable sentence or command when it is determined that the user's spoken command has finished; and

means for providing as an output parameter a determined measure of whether the user's spoken word or words to the device are likely to be part of a recognisable sentence or command before it is determined that the user's spoken command has finished.

As will be appreciated by those skilled in the art, these aspects of the present invention may include any one or more or all of the preferred and optional features of the invention described herein. Thus, for example, the determined recognition measures are preferably used to select an icon to display to a user to convey an acknowledgement (or otherwise) of their spoken commands, although they could of course be used for other purposes instead or as well. Similarly, the recognition measures are preferably output after particular, preferably predetermined, time intervals or selected numbers of words (e.g. one or two or three) are detected. Equally, as discussed above, the finish of a user's spoken command is preferably determined by detecting a particular, preferably predetermined, event or events, such as pause in their speech of greater than a particular, preferably predetermined, duration, and/or some other user action, such as actuating an input of the device (e.g. pressing or releasing a key).

The measure of whether a user's spoken word or words to the device are likely to be part of a recognisable sentence or command could, e.g., simply comprise a measure of whether the spoken word or words have been recognised or not. However, in a preferred embodiment, the measure is an assessment of whether, e.g., of the probability that, the spoken word or words are part of a recognisable sentence or command, as discussed above. This could be based for example, on a statistical analysis of the user's speech, as discussed above, or carried out in some other suitable manner.

The system could also (and, indeed, preferably does also) determine when a user starts a spoken command to the device (e.g. by detecting the start of the user's speech, for example after a (e.g. predetermined) period of silence or no speech, e.g. when the device is in a command accepting or expecting mode of operation). In that case, the determined recognition measure would be output both when it is determined that the user's spoken command has finished, and in the period between the determination of the start of the command and when it is determined that the command has finished.

It is also preferred that the apparatus or system comprises a speech recognition unit or engine, and that the recognition measure is a confidence value returned by the speech recognition unit. This speech recognition unit may be provided on the device itself, or may be all or in part provided on or via the communications network infrastructure, and, e.g., in a distributed fashion, as is known in the art.

It will be appreciated that in order to display the icon (and to select the icon for display) appropriately, the device, system, or apparatus, etc., will need to know the current state or condition of the status factors in question. The current state of the factors to be displayed can be determined for this purpose in any suitable and desired manner. For example, this information may be determined on and by the electronic device itself, for example where it relates to the status of the device or its components. On the other hand, the status of some factors, such as, e.g., communications network conditions, may be determined elsewhere, such as by components on the communications network infrastructure, and the relevant information then provided to the device (e.g. via data signalling) to allow the icon to be (selected and) displayed.

The actual, e.g., value, of the status factor or factors in question can be determined in any appropriate and suitable manner, such as by using techniques already known in the art. For example, an existing signal strength detector of the device could be used to assess the signal strength, or a count of successfully received data packets used to assess packet data loss. For a speech-enabled interface, a confidence or other value returned by a speech-recognition engine could be used to indicate how well a user's speech commands can be recognised, and/or, e.g., wave analysis could be used to assess how adequate the user's environment is for speech recognition (e.g. how noisy it is).

Thus, in a preferred embodiment, the method, device, system, or apparatus includes a step of or means for determining the current status of one or more of the factors that the icon to be displayed relates to, and then displaying the icon (and, e.g., selecting the icon to be displayed) on the basis of that determination. Similarly, the method, device, system, or apparatus preferably also or instead includes a step of or means for receiving information relating to the current status of one or more of the factors that the icon to be displayed relates to, and then displaying the icon (and, e.g., selecting the icon to be displayed) on the basis of that information.

The icons preferably can be (and indeed preferably are) displayed automatically, and preferably in an unsolicited manner (i.e. such that the icons are provided automatically and spontaneously (e.g., when a particular icon “triggering” condition or criteria is met, rather than, e.g., needing a request by a user to trigger the display of the icon). However, it would also, e.g., be possible to provide the icon additionally or solely in response to user requests (inputs).

The icon could, e.g., be displayed intermittently, for example in response to particular events, such as a particular status factor crossing a given threshold value. Alternatively or additionally, the icon could be displayed continuously while the device is in use. In a particularly preferred embodiment, the icon is continuously displayed while the device is in use, and the system periodically monitors the factors in question and periodically updates the icon display (e.g. at predetermined time intervals) accordingly. Such an arrangement would provide a constant supply of status information to the user.

In a particularly preferred embodiment, the icon is continuously displayed and has the appearance of a video clip or sequence, i.e. such that there is a continuous transition and sequence as the icon changes appearance to convey the changing status of the device and its operation, etc. Thus, most preferably, the icon that is displayed comprises a continuous sequence of (varying) images. Most preferably these images are rendered in real-time in response to the determined status conditions of the device.

It is believed that such an icon display arrangement may be new and advantageous in its own right. Thus, according to a seventh aspect of the present invention, there is provided a method of providing status information to a user of an electronic device, the method comprising:

displaying on a display of the electronic device an icon in the form of a continuous sequence of images to convey status information relating to the operation or condition of the device.

According to an eighth aspect of the present invention, there is provided an apparatus or system for providing a user interface for an electronic device, comprising:

means for displaying on a display of the electronic device an icon in the form of a continuous sequence of images to convey status information relating to the operation or condition of the device.

According to a ninth aspect of the present invention, there is provided an electronic device, comprising:

a display; and

means for displaying on the display an icon in the form of a continuous sequence of images to convey status information relating to the operation or condition of the device.

As will be appreciated by those skilled in the art, these aspects of the present invention can include any one or more or all of the preferred and optional features of the invention discussed herein. Thus, for example, the icon is preferably used to convey status information relating to two or more status factors of the device simultaneously.

It should be noted here that although in the present invention a status icon as discussed above will be displayed at least some of the time, it would be possible for other status icons still to be displayed as well. Such icons could, e.g., relate to a single status factor. It would also, e.g., be possible to display plural icons that convey multiple status factors as in the present invention, if desired.

In a particularly preferred embodiment, the icon that is displayed in accordance with the present invention is in the form of or comprises a human face. The Applicants have recognised that the human face is particularly suited to conveying information regarding plural status factors simultaneously, since it can, e.g., convey a range of values or factors using different expressions. Human users are also used to and familiar with interpreting facial expressions to derive multiple and varying forms of information. A human face can also more readily convey varying ranges or values of information. The Applicants accordingly believe that a human face is particularly and advantageously suitable for use as an icon in accordance with the present invention.

Thus according to a tenth aspect of the present invention, there is provided a method of providing status information to a user of an electronic device, the method comprising:

displaying on a display of the electronic device an icon in the form of a human face to convey status information relating to the operation or condition of the device.

According to an eleventh aspect of the present invention, there is provided an apparatus or system for providing a user interface for an electronic device, comprising:

means for displaying on a display of the electronic device an icon in the form of a human face to convey status information relating to the operation or condition of the device.

According to a twelfth aspect of the present invention, there is provided an electronic device, comprising:

a display; and

means for displaying on the display an icon in the form of a human face to convey status information relating to the operation or condition of the device.

As will be appreciated by those skilled in the art, these aspects of the present invention can include any one or more or all of the preferred and optional features of the invention discussed herein. Thus, for example, the icon in the form of a human face is preferably used to convey status information relating to two or more status factors of the device simultaneously.

In a particularly preferred arrangement of these embodiments and aspects of the invention, the expression of the face icon is used to convey status information. Thus, icons having plural different facial expressions are preferably predetermined and stored for use. Most preferably the expressions used in natural human interaction are used to convey the appropriate information. Preferably at least “happy”, “sad” and “neutral” expressions can be presented.

In a preferred embodiment, an expression that shows understanding (or not) of a user's spoken commands can be presented. This is preferably done to acknowledge understanding of a user's spoken command, as discussed above. Preferably the face is arranged to smile and/or nod briefly to convey such acknowledgement and understanding. Similarly, a frown or shake of the head is preferably used to indicate that a user's spoken commands have not been recognised.

It is also preferred to be able to provide a “not ready” expression, such as having an absent or see-through or out-line face, or a face with its eyes shut. This could be used, e.g., when the device's resources are not yet activated or acquired (e.g. the network connection has yet to be established).

In a preferred embodiment, the icon in the form of a face includes the upper torso and arms and hands, as well as the face. This allows a greater variety of expressions and status conditions to be conveyed by the icon. Most preferably in such an arrangement, the icon's hands and/or arms are used to convey information regarding one (or more than one) status condition, while a facial expression is preferably used to convey information regarding another status factor or factors. For example, the icon's hands or face could be used to give an “I can't hear” gesture where the device cannot detect a user's spoken commands (and/or, e.g., it is determined that the user's background noise levels are relatively high (e.g. such that speech recognition may be difficult)—in this case the expression could be given before the user starts to speak), while the face or hands, respectively, has an “I don't understand” expression to convey an inability to recognise the user's spoken commands. It would also, e.g., be possible to show the icon as “dirty” or distorted to convey poor communications channel reception.

Where a facial icon is used, then the icon is preferably arranged such that there is or can be eye contact with the icon. This again enhances the user's interaction with and understanding of the icon.

Where a facial icon is used, the icon could, e.g., simply be an iconic representation of a face, or it could be (and is preferably), a more realistic, life-like, image (drawing or photograph) of a face. In a preferred embodiment, both an “iconic face”, and a more realistic image of a face can be used for any given status icon (with the more realistic image being used, e.g., when a “close up” icon is required).

In a particularly preferred embodiment, the icon, e.g., face, that is displayed can be and preferably is selected in accordance with a user expertise measure determined for the user of the device. For example, in the case of a multi-modal, speech-enabled device, a measure of the user's expertise in using the device may be determined and then the displayed icons selected accordingly, for example to convey more attention to a less expert user, and/or more confidence to a more expert user. Such user expertise determination selection of the icons can be done in any suitable and desired manner.

It would also be possible to, and indeed it is preferred to, display the icons or select the icons for display on the basis of a selected, e.g., predefined “emotion”, for example relating to an application running on or being accessed by the device. For example, characters in a game may have particular emotional states, such as happy or sad, that could be conveyed using the icon, or an application may itself be considered to have a given emotional state, such as happy or sad, depending, e.g., on its underlying business logic. This type of arrangement would be particularly applicable where images of faces are used as the status icons.

It is accordingly preferred for the icon to be able to convey plural “emotional” states simultaneously. For example, an application might be “happy”, but the user's interaction may be poor or “uncomfortable”. An icon in the form of a face is particularly suited to conveying such information.

The above operations and functions in accordance with the present invention can be carried out in any appropriate unit or component of the device or system in question. For example, an appropriate rendering engine can be included in the device for rendering the icons to be displayed.

In a preferred embodiment, the icons and the criteria for displaying them are provided by (and preferably performed by) an application or applications of the electronic device, such as a game. Such applications could, e.g., be executed on and run on the device itself, or could, e.g., be executed (at least in part) elsewhere, but accessed by the device (e.g. via a communications network to which the device is coupled), as is known in the art. The or each device application preferably has a defined or predetermined set of status icons (e.g. as part of the application logic) that it then selects from accordingly. This allows, e.g., the icons to be used to more easily be tailored specifically to the application in question.

In a particularly preferred embodiment, the various functions of the present invention, such as the sets of icons that may be provided, and the icon selection process (e.g. the status factor value thresholds at which a new icon is selected) can be varied in use, for example by reprogramming or reconfiguring the device or system or parts of it.

The various functions and components described above and herein that comprise or form part of the present invention, or a device incorporating the present invention, may, as is known in the art, be performed by or provided as discrete, individual components, e.g., in the device itself. However, as will be appreciated by those skilled in the art, they may also be performed by or provided, as, e.g. different “parts” of the same component (e.g. processing unit) or in a distributed form, on the device or elsewhere. It would also be possible, as is known in the art, for components of the “device” or functions of the invention and parts of the system of the invention to be distributed across the overall communications system network, e.g. to be performed in part on the device itself and, e.g., also on a component or components, such as a server, of the communications network, etc., to which the device connects.

Thus, for example, in one embodiment the system of the present invention could comprise one or more status determining components arranged on the communications network infrastructure that provide information to a processing and rendering unit on the electronic device which then displays an icon on the device accordingly. On the other hand, in another embodiment, the system could comprise the status determining components together with a processing unit that receives the status information all arranged on the network side, with the processing unit then, e.g., simply sending to the electronic device instructions to display the desired icon. In this arrangement, the electronic device could take more of a passive role, with the icon processing all being performed on the communications network. Of course, other arrangements, such as intermediate these two embodiments, would be possible.

It is envisaged that the present invention will have particular application to mobile or portable electronic devices, such as mobile 'phones, PDAs, in-car systems, etc., i.e. in particular to devices that may have constrained user interfaces. Thus in a preferred embodiment, the electronic device is a portable device, and most preferably a mobile communications device.

However, the present invention can, as will be appreciated by those skilled in the art, also be used for and applied to the user interfaces of other electronic devices, such as personal computers (whether desktop or laptop), and more general household appliances that include some form of electronic control, such as washing machines, cookers, etc. It is also envisaged that the present invention may have particular application to user interfaces for interactive television arrangements, e.g., where an interactive television arrangement is provided with and may be controlled by a multimodal user interface. The present invention accordingly extends to an electronic device that can be operated in accordance with or that includes the methods, system or apparatus of the present invention.

It is believed that the present invention is particularly useful for and suited to providing information regarding the status of a user's interactions with a multi-modal, and in particular, speech-enabled, user interface of an electronic device, as it is a particularly effective way of, e.g., conveying to a user how his or her “conversation” with the device is progressing, particularly when an icon in the form of a face is used. It is also the case that a number of factors typically influence the operation of a multi-modal user interface, and so having an icon that can convey this information simultaneously is particularly advantageous.

Thus, in a particularly preferred embodiment, the icon that is displayed relates to a factor and preferably to plural factors relating to or that could influence the operation of a multi-modal and/or speech-enabled user interface of the device.

The Applicants have further recognised that the icon can be used to encourage a user to interact with a multi-modal interface, and to, e.g., speak longer sentences, for example by using the icon to suggest encouragement or an acknowledgement or partial acknowledgement of a user's spoken commands, as discussed above. Thus, in a preferred embodiment, the icon can and preferably does convey an acknowledgement or encouragement to a user of their spoken commands to the device. Again, the use of an icon in the form of a human face is particularly effective for this (in which case, the icon could, e.g., nod or smile to encourage and acknowledge the user).

The Applicants believe that the provision of an icon relating to the status of a multi-modal user interface, and/or, e.g., to the status of a user's interactions with the interface (e.g. with a speech-enabled user interface) may be new and advantageous in its own right.

Thus, according to a thirteenth aspect of the present invention, there is provided a method of providing status information to a user of an electronic device, the method comprising:

displaying on a display of the electronic device an icon representing the status of an operation or condition of the user-interface of the device.

According to a fourteenth aspect of the present invention, there is provided an apparatus or system for providing a user interface for an electronic device, comprising:

means for displaying on a display of the electronic device an icon representing the status of an operation or condition of the user-interface of the device.

According to a fifteenth aspect of the present invention, there is provided an electronic device, comprising:

a display; and

means for displaying on the display an icon representing the status of an operation or condition of the user interface of the device.

As will be appreciated by those skilled in the art, these aspects of the invention may include any one or more or all of the preferred and optional features of the invention described herein. Thus, for example, the icon preferably relates to the status of more than one factor that relates to the user interface, and is preferably in the form of a human face. Similarly, the icon preferably relates to the status of a user's interactions with the device, and preferably with a speech-enabled interface of the device. It is also preferred, e.g., for the icon to, e.g., convey the recognition status by the device of spoken words or commands given by the user.

Thus, according to a sixteenth aspect of the present invention, there is provided a method of providing a speech-enabled interface for an electronic device, the method comprising:

determining a measure of whether or not a spoken word or words of a user are likely to be part of a recognisable sentence or command; and

displaying on a display of the electronic device an icon acknowledging that the user's word or words has been recognised on the basis of the determined measure of whether or not the spoken word or words are likely to be part of a recognisable sentence or command.

According to a seventeenth aspect of the present invention, there is provided an apparatus or system for providing a speech-enabled interface for an electronic device, the apparatus or system comprising:

means for determining a measure of whether or not a spoken word or words of a user are likely to be part of a recognisable sentence or command; and

means for displaying on a display of the electronic device an icon acknowledging that the user's word or words has been recognised on the basis of the determined measure of whether or not the spoken word or words are likely to be part of a recognisable sentence or command.

According to an eighteenth aspect of the present invention, there is provided an electronic device, comprising:

a speech-enabled user interface, whereby a user may speak commands to operate the device;

a display;

means for determining a measure of whether or not a spoken word or words of a user are likely to be part of a recognisable sentence or command; and

means for displaying on the display of the electronic device an icon acknowledging that the user's word or words has been recognised on the basis of the determined measure of whether or not the spoken word or words are likely to be part of a recognisable sentence or command.

As will be appreciated by those skilled in the art, these aspects of the invention may again include any one or more or all of the preferred and optional features of the invention described herein. Thus, for example, the icon is preferably in the form of a human face, and preferably acknowledges recognition of a spoken word or words by nodding and/or smiling. It is similarly preferred that a measure of whether the spoken words have been recognised (and the corresponding icon display) is performed whilst a user is speaking (so as to provide a “partial” acknowledgement, as discussed above), and not just once a user has finished their sentence (e.g. command). Preferably the measure is determined and used to convey an acknowledgement after each spoken word, or after every two or every three spoken words. Preferably it is done at least as frequently as every three spoken words.

Similarly, the measure of whether a user's spoken word or words has been recognised is preferably a confidence value determined by an automatic speech recognition unit (which may, e.g., be implemented on the device itself, or, e.g., distributed between the device and an external network to which the device is coupled or in communication with), and the icon is displayed in accordance with, e.g., whether the recognition measure (e.g. confidence value) is above or below a particular, e.g., selected (and preferably predetermined) threshold or thresholds. For example, an acknowledgement icon could be displayed if the recognition measure (e.g. confidence value) is above the threshold, or a non-recognition icon (e.g. a shake of the head or a frown if a facial icon) displayed if the recognition measure is below the same or a different threshold.

As will be appreciated by those skilled in the art, all of the aspects and embodiments of the invention discussed herein may include any one or more or all of the preferred and optional features of the invention described herein, as appropriate.

The methods in accordance with the present invention may be implemented at least partially using software e.g. computer programs. It will thus be seen that when viewed from further aspects the present invention provides computer software specifically adapted to carry out the methods herein described when installed on data processing means, a computer program element comprising computer software code portions for performing a method or the methods herein described when the program element is run on data processing means, and a computer program comprising code means adapted to perform all the steps of a method or of the methods herein described when the program is run on a data processing means. The invention also extends to a computer software carrier comprising such software which when used to operate an electronic device, system, or apparatus comprising data processing means causes in conjunction with said data processing means said device, system or apparatus to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

A number of preferred embodiments of the present invention will now be described by way of example only and with reference to the accompanying drawings, in which:

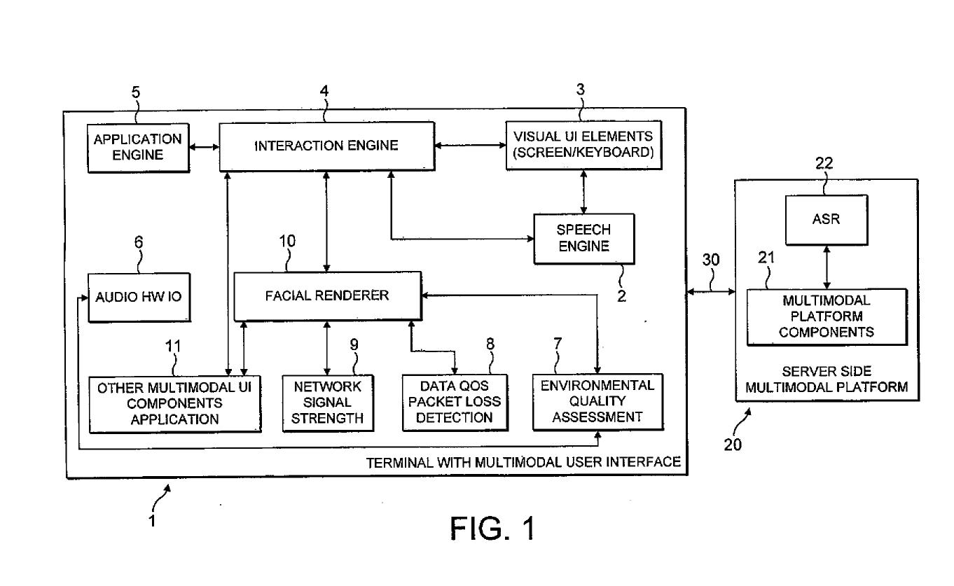

FIG. 1 shows schematically a mobile communications device that can be operated in accordance with the present invention; and

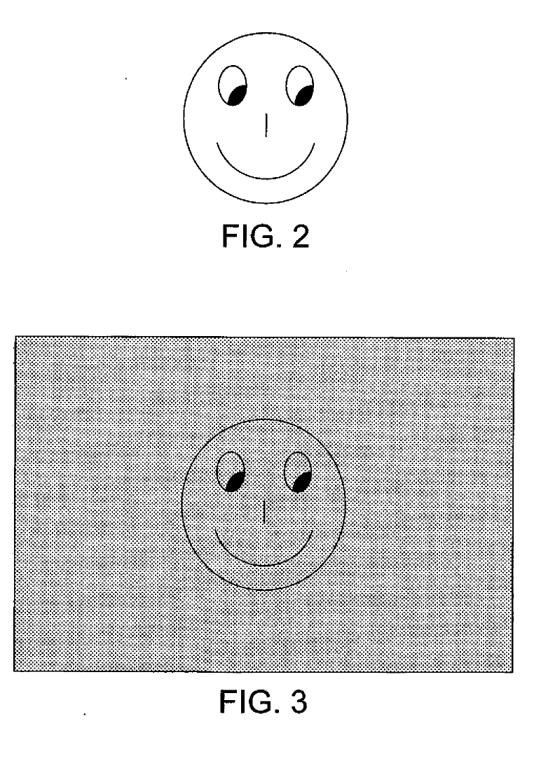

FIGS. 2 to 7 show schematically exemplary icons that can be displayed on the mobile communications device of FIG. 1 in accordance with the present invention.

FIG. 1 shows schematically an electronic device 1 in the form of a mobile telephone that includes a multimodal user interface arranged to operate in accordance with the present invention. In the mobile telephone shown in FIG. 1, the user interface has three interaction modes, namely a keypad, a screen, and the ability to recognise speech commands and to speak synthesised text (e.g. to provide speech prompts and information to a user).

In the arrangement shown in FIG. 1, the multimodal user interface's component parts are distributed between the mobile telephone 1, and a server 20 on the mobile communications network to which the telephone 1 is coupled. However, other arrangements would, of course, be possible, for example with the multimodal interface being entirely implemented on the mobile telephone 1.

As shown in FIG. 1, the mobile telephone 1 includes, inter alia, a speech engine front-end 2, visual user interface elements 3 (which in the present embodiment are in the form of screen and keyboard), an interaction engine 4, an application engine 5, an audio hardware input/output unit 6, an environmental quality assessment unit 7, a data quality of service and packet loss detection unit 8, a network signal strength determination unit 9, a rendering unit 10, and other multimodal user interface components and applications 11. The mobile telephone will, of course, include other, components that are not shown, such as a radio transmitter and receiver, etc., as is known in the art.

The server side multimodal platform 20 (i.e. the components and functions of the multimodal user interface provided by the mobile telephone 1 that are implemented on a server of the communications network in the present embodiment) includes multimodal platform components 21, and a speech engine 22.

The multimodal platform components 21 implemented on the server side may include, for example, protocol stacks, synchronisation mechanisms, interaction event queues, multimodal application specific data, etc.

The speech engine 22 includes an automatic speech recognition unit that analyses, as is known in the art, audio commands (words) spoken by a user and interprets those commands. It also determines a so-called “confidence value” for each spoken command that it interprets. (As is known in the art, a speech engine will typically determine a parameter commonly referred to as a “confidence value” that is a measure of how “confident” the speech engine is of its recognition of a user's spoken command. This confidence value can be used as a parameter for assessing whether or not a user's spoken words or commands have been recognised.) The speech engine 22 may (and does) also include, as is known in the art, a text to speech engine for converting text into speech.

In order to facilitate such speech recognition operation, the mobile terminal 1 provides audio inputs that it receives and that are to be processed by the automatic speech recognition unit of the speech engine 22 to the server side 20 via a communications link 30 between the mobile telephone 1 and the server side multimodal platform 20 (i.e. the data link with the communications network to which the mobile telephone 1 is connected). The multimodal platform components 21 and speech engine 22 correspondingly return spoken command interpretation data and associated confidence values, together with, e.g., features extracted from the original audio data, interaction events, and/or recognition events, to the mobile telephone 1 in response thereto. In this way, the mobile terminal 1 and the server side multimodal platform 20 act as a distributed speech engine, as is known in the art.

The speech recognition unit of the speech engine 22 also provides the speech recognition confidence values that it determines to, inter alia, the rendering unit of the mobile telephone 1, so that the rendering unit 10 can use the determined speech recognition confidence values to determine an icon to be displayed (as will be discussed further below).

In the present embodiment, the automatic speech recognition unit of the speech engine 22 can indicate speech recognition activation events, speech recognition events (including confidence metrics), and audio in/out data. The automatic speech recognition unit of the speech engine 22 of the present embodiment can provide confidence measurements at any time during a user's speech, as well as providing an overall confidence value once a user has finished speaking their commands. The confidence value that is returned includes a confidence measure, but may also relate to, for example, recognition events, audio frames, etc., as is known in the art.

The interaction engine 4 of the mobile telephone 1 synchronises the control of the user interface elements of the telephone 1 and coordinates the operation of the user interface and the applications running in the application engine 5, as is known in the art. For example, it will monitor speech recognition events, and respond appropriately to those events, for example by controlling the visual user interface elements 3 to provide a particular display on the screen. Similarly, the interaction engine 4 also responds to keyboard events via the user interface 3 and again, e.g., will control the user interface element 3 to change the screen display, and/or control the speech engine front-end 2 to provide an appropriate text to speech prompt (whether by itself, where the speech engine front-end has that functionality, or via the speech engine 22 on the server side).

In order to do this, the user interface elements 3 for example, post and receive events from the interaction engine 4. For example, they may receive commands from the interaction engine 4 to display particular information on the screen, and/or provide to the interaction engine information detailing text that a user has typed on the keyboard.

As discussed above, the distributed speech processing platform, comprising the speech engine front-end 2 on the mobile telephone 1 and the server side multimodal platform 20, operate, together with the interaction engine 4, to provide a speech-enabled interface of the mobile telephone 1. In particular, the interaction engine 4 can control the speech engine front-end 2 and server side platform 20 to provide text to speech prompts to a user, and can send recognition activation requests to the speech engine front-end 2 and server side platform 20 when it wishes to determine whether a speech command has been attempted by a user. The speech engine front-end 2 and server side platform 20 act to post speech recognition events (whether positive or negative) to the interaction engine 4, as is known in the art, for the interaction engine then to process further. (As is known in the art, this process is normally initiated by sending a speech recognition activation event to the automatic speech recognition unit of the speech engine 22, which will then start processing the audio data and trying to interpret it and will get recognition events as it does so).

The application engine 5 runs the applications of the telephone 1 that, e.g., a user may wish to use or access. In this embodiment, an application running on the application engine 5 can initiate user interface changes or update the user interface when the application is running. It does this by providing appropriate command instructions to the interaction engine 4, which then controls the speech engine 2, server side platform 20 and/or visual user interface elements 3 accordingly. Thus the application engine 5 can, for example, provide to the interaction engine 4 commands and data to activate application user interface events, such as activating voice dialogues, activating visual menus, and getting user interface inputs, etc.

The application engine 5 can also provide information to the rendering unit 10 regarding whether or not the desired application has, e.g., been activated.

In this embodiment, information is also provided to the rendering unit 10 regarding, e.g., whether or not a successful connection to the communications network has been established, and, e.g., whether or not the system is ready to take speech commands from a user.

The audio hardware input and output unit 6 of the mobile telephone 1 captures a user's voice and ambient noise and is also used to provide audio voice prompts. It provides audio data (comprising both the user's speech and ambient noise) that it captures to, inter alia, the environmental quality assessment unit 7 of the mobile telephone 1.

The environmental quality assessment unit 7 performs wave analysis on the received audio data in order to determine how adequate the user's current environment is for speech recognition (e.g. on the basis of the current level of ambient noise), and the quality of the user's spoken speech. It provides, inter alia, a measure of the quality of the user's current environment for speech recognition and/or of the quality of the input speech itself, to the rendering unit 10.

The data quality of service unit 8 of the mobile telephone 1 analyses communications network traffic in order to assess the quality of the data that the mobile telephone 1 is receiving. This unit 8 firstly determines whether and how many data packets or datagrams may have been lost during transmission to or from the mobile telephone 1. In this preferred embodiment, this assessment relates to data packets that relate solely to the speech-enabled interface of the mobile telephone 1, although other arrangements would, of course, be possible. In order to facilitate this arrangement, each data packet or datagram is numbered such that its loss can be detected. The number and frequency of data packet or datagram loss is provided, inter alia, to the rendering unit 10.

The data quality of service unit 8 also determines in this embodiment if any received packets or datagrams are corrupted and how severe any such corruption is. This can be done, for example using error correction and detection techniques, as is known in the art.

The data quality of service unit 8 provides its determined information about the data network quality, such as packet loss events, the proportion of data packets that have been lost or damaged, etc., inter alia, to the rendering unit 10.

The network signal strength unit 9 of the mobile telephone 1 determines, as is known in the art, the current communications network signal strength being received by the telephone 1 and provides that measurement as an output to, inter alia, the rendering unit 10.

The other multimodal unit interface components and applications 11 of the mobile telephone 1 can include, for example, protocol stacks capable of capturing confidence measurements from the automatic speech recognition unit of the speech engine 22 of the server side multimodal platform 20, and/or protocol stacks that can determine user expertise metrics or application-specific emotional data information, etc. Again, data representing, for example, currently determined user expertise and/or application defined moods or emotions can be provided by this unit 11 to the rendering unit 10, as shown in FIG. 1.

The rendering unit 10 of the mobile telephone 1 includes a rendering engine that can be used to display multiple, continuously varying images of human faces on the screen 3 of the mobile telephone 1. The rendering unit 10 can also adds effects to the rendered image, such as noise, vary its brightness, change its size or level of detail, cause it to blink or flash, etc., and can render and display faces having a combination of expressions. As will be discussed further below, the rendering unit 10 is used to display icons in the form of human faces that reflect the status of factors relating to the operation or condition of the mobile telephone 1.

As discussed above, the rendering unit 10 receives inputs from a number of status factor determiners of the mobile telephone 1, including the environmental quality assessment unit 7, the data quality of service unit 8, the network signal strength unit 9, the application engine 5, the other multimodal interface components 11, and the automatic speech recognition unit of the speech engine 22. The rendering unit 10 uses the status information that it receives to select an icon to be displayed to convey information about the current status of the mobile telephone 1 to the user.

In effect, the rendering unit 10 takes all the input signals it receives, including an assessment of the environmental noise, speech signal quality, data network status, signal strength, determined user expertise, a speech recognition confidence value (whether a final or interim value), and/or application-defined mood or emotional information, and determines and displays an icon that helps the user during the interaction process. This will be discussed further below.

It should be noted here that FIG. 1 simply shows schematically the logical layout of some of the components of the mobile telephone 1 and the server side multimodal platform 20. As will be appreciated by those skilled in the art, the actual software and/or hardware components comprising the architecture of the mobile telephone 1 and server side platform 20 may be structured differently, and, indeed, in any appropriate manner. Furthermore, the components shown in FIG. 1 may be distributed across the telephone and/or across the network in which the telephone operates, and, equally, the multimodal interface could, e.g., be implemented on the mobile telephone alone, if desired. Similarly, the various inputs to the rendering unit 10 that are used to determine the icons to be displayed can be varied as desired.

It should also be noted that not all of the applications, or indeed of the mobile telephone's 1 functions, need be provided with multimodal user interface functionality (and, in particular, with the speech-enabled interface). For example, a single one or a selected one or ones of the applications running on the application engine 5 could have multimodal functionality, with the remaining applications and the telephone 1 as a whole simply being operated via the visual user interface elements 3. Of course, it would also be possible for all applications and the telephone as a whole to be operable by the multimodal interface, if desired.

As discussed above, the rendering unit 10 uses the current status information provided to it to display an icon on the display screen 3 of the mobile telephone 1 to convey the current status of the various determined factors and conditions to the user. In the present embodiment, the icon that is displayed by the rendering unit 10 is in the form of a human face that can show varying expressions and emotions, although other arrangements would, of course be possible. The expressions used are those that would typically be used by a human during a conversation or interaction with another person. Thus, for example, the facial icon will, as discussed below, nod or smile briefly as and when spoken commands are recognised, and can express several emotions, such as being “sad”, “neutral” and “happy”.

The face icon is displayed continuously (such that it, e.g., appears as a “video clip”), but will vary in appearance, in accordance with the current status of the factors and conditions discussed above. In the present embodiment, the displayed icon is updated at predetermined intervals (there is a clock in the telephone's architecture that triggers icon updates).

The actual form of the icon that is displayed at any given time is determined as follows.

Firstly, the measured signal strength is mapped to the brightness of the displayed face. In particular, the higher the signal strength, the brighter the face that is displayed, and vice-versa.

Loss of data packets is represented as “video noise” on the displayed facial image (icon). In particular, if a packet of information is lost, the displayed face is temporarily disturbed or interfered with, e.g. to give the impression of a not properly tuned TV. An alternative to this arrangement would, e.g., be to allow the image to blink or flash temporarily when a network packet loss is detected.

Such displayed noise readily allows the user to determine the quality of the data network. Such determination is important, because in many speech-enabled devices, the speech-enabled interface resources are distributed as between the device itself and the communications network, and so the exchange of data packets between the device and the network has a direct influence on the successful operation or otherwise of the speech-enabled interface. It is therefore useful and important to be able to convey this information to a user.

In effect, the arrangement of the above two factors is such that problems associated with the status of the communications network to which the mobile telephone 1 is coupled and/or its coverage are presented as noise additions or effects in the facial image that is displayed.

Where it is determined that the mobile telephone 1 has a non-active status, e.g., where mobile telephone 1 resources are not yet acquired or activated, or the connection to the communications network has not yet been established, then the face icon is displayed with an expression showing that it is “not ready”, for instance with its eyes shut. Alternatively or additionally, the face icon could be shown as being “absent”, for example by showing it in an outline form, to convey this information. It would also e.g., be possible to arrange the displayed face to blink or flash whilst a network connection is being established, or a terminal resource is being activated.

The output from the environmental quality assessment unit 7 is used to modify the expression of the face icon that is displayed to show how appropriate the user's environment is for detection of the speech user's spoken commands, i.e. in effect to demonstrate how easily the speech engine front-end 2 and server side multimodal platform 20 can detect (hear) the user's spoken commands. The face's expression is used to convey this information.

The output of the automatic speech recognition unit of the speech engine 22 of the server side multimodal platform 20, such as the confidence value returned by the speech recognition unit as discussed above, is used to modify the expression of the face that is displayed to show whether or not the system is currently able to recognise the user's spoken commands. Thus, for example, an acknowledgement expression such as a nod or smile, is used when a spoken command or commands is recognised (and the icon can frown or shake its head when spoken commands are not being recognised). Recognition of a spoken word or words is based on whether the determined confidence value is above or below a selected, predetermined threshold confidence value (although other arrangements would, of course, be possible).

In this embodiment, the arrangement for conveying speech recognition (or not) is arranged such that when individual words or partial commands are recognised, the displayed facial icon will acknowledge or give a partial acknowledgement of those commands. This is achieved by determining, as discussed above, “interim” confidence values whilst the user is speaking, and displaying the icon accordingly. This has the effect of encouraging the user as they speak their commands, thereby encouraging the user to interact better with the speech-enabled interface of the mobile telephone 1, and also, for example, encouraging the user to use longer and more complex spoken commands and sentences. This will allow the user to get better usage and interaction with the speech-enabled interface.

Finally, the icon rendering and presenting arrangement is arranged such that the face that is displayed can also be used to convey an overall overview of, for example, the underlying status of the mobile telephone 1, and, in particular, of how well or otherwise the user is interacting with the mobile telephone 1. This information is preferably conveyed by providing an appropriate expression on the displayed face. This is useful because, for example, although there might be some problems or difficulties, such as some environmental noise or packet loss, etc., it may be that in practice the overall interaction with the user is satisfactory or good. It is useful therefore for the displayed icon to be able to convey this.

As well as the above factors and criteria governing the selection and display of the icons in the present embodiment, it would be possible to use other factors and criteria to select or modify the icon display. For example, a measure of the user's expertise in interacting with the mobile telephone 1 and, in particular, with its speech-enabled interface, could be used to modify the icons that are displayed. Thus, for example, a high user expertise measure could result in displaying icons that appear more confident, whereas a lower, less expert user, might be provided with icons that appear more attentive or sympathetic. The way that the user expertise is measured in this regard can be selected as desired. It could, for example, be based on the average confidence value for a user's spoken commands returned by the automatic speech recognition unit 22.

It would also be possible to modify the icon according, e.g., to a measure of the “emotional state” of the application currently being executed or used, or, for example, of particular factors relating to an application. Thus, for example, during a game, a character may have its own particular emotional status, which could be conveyed by the displayed icon. Similarly, a given application might be happy or sad according to its underlying business logic, and again the icon could be used to convey this.

In these arrangements, the icon may, e.g., need to be able to convey two emotions, for example, the underlying “application” emotion, together with, for example, an emotion indicating the state of interaction with the user, e.g., whether the speech engine can detect (hear) a user's spoken commands or recognise them. For example, an underlying application might be “happy”, but the overall interaction may be “uncomfortable” for example due to environmental noise. It is preferred for the facial icon that is displayed to allow both expressions to be recognised by the user, so as to meet both interaction and application objectives.

It will be appreciated from the above that the facial icon that is displayed may and indeed typically will be required to display or convey multiple emotional states at the same time. It is an advantage of the use of an icon in the form of a face that such an icon can more readily convey multiple emotions and expressions at the same time.

FIGS. 2 to 7 show examples of the icons in the form of faces that are displayed in the present embodiment in given circumstances.

FIGS. 2 and 3 show “happy” icons displayed when communications signal strength is okay (FIG. 2) and when there has been some packet loss in communication with the communications network (FIG. 3). In the latter case, the facial icon is displayed with some background “noise”, or as though it has been interfered with, as shown in FIG. 3, so as to convey the information that some data packets have been lost.

This “happy” icon may be used, e.g., to indicate when the system is successfully recognising and responding to speech commands given by a user. Thus, the icon shown in FIG. 3 can be used to indicate that the system is successfully recognising and responding to speech commands given by a user but there is still some packet loss occurring. In this case, as shown in FIG. 3, the packet loss is conveyed by making the image “noisy”, but the fact that the system is recognising the user's spoken commands is conveyed by giving the displayed face a happy or smiling expression. In this way, the single icon that is displayed conveys to the user information both regarding the status of the underlying operational conditions or factors of the mobile telephone 1, and regarding the overall status of the user's interaction with the speech-enabled interface of the mobile telephone 1.

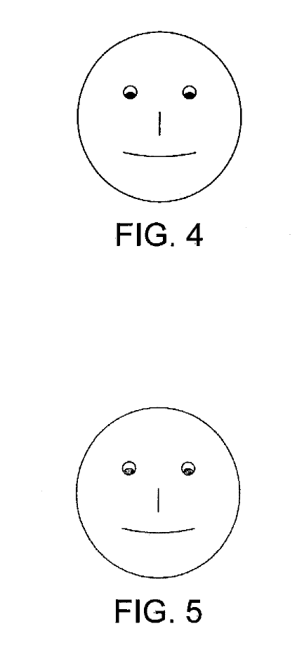

FIGS. 4, 5 and 6 show “neutral” emotion icons as they would be displayed for three different communications conditions. FIG. 4 shows the icon displayed when the communications signal strength is okay. FIG. 5 shows the icon used to convey a lower or weaker signal strength (when a lower or weaker signal strength is detected. As can be seen from a comparison of FIGS. 4 and 5, the reduced signal strength is conveyed in the icon by graying out or reducing the brightness of the icon, as shown in FIG. 5.

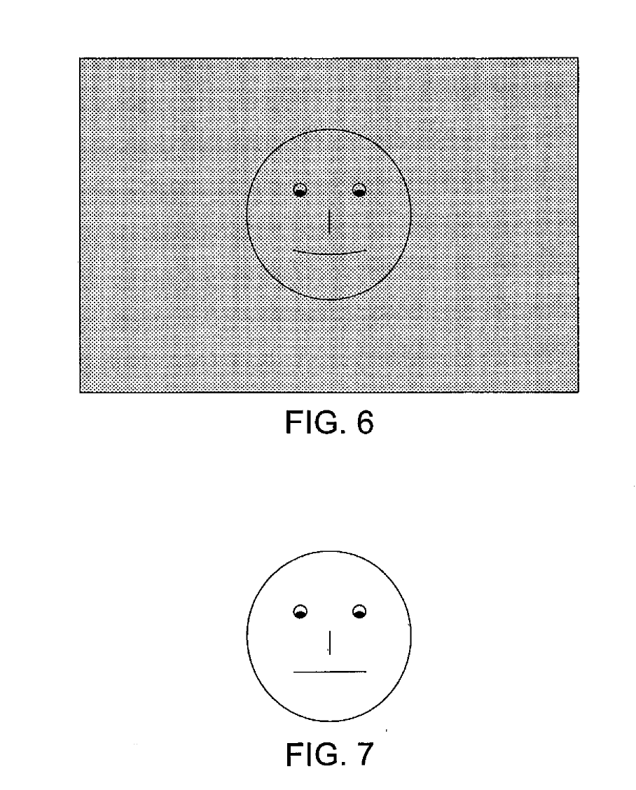

FIG. 6 shows the “neutral” icon displayed in the situation where there has been some packet loss in communication with the communications network. Again, the icon is displayed with some background “noise” so as to convey the information that some data packets have been lost.

Finally, FIG. 7 shows the icon that is displayed when the system and mobile telephone 1 is operating “normally”.

Although the present embodiment has been described above with reference to a mobile telephone, as will be appreciated by those skilled in the art, the present invention is applicable to more than just mobile 'phones, and may, e.g., be applied to other to mobile or portable electronic devices, such as mobile radios, PDAs, in-car systems, etc., and to the user interfaces of other electronic devices, such as personal computers (whether desktop or laptop), interactive televisions, and more general household appliances that include some form of electronic control, such as washing machines, cookers, etc.

It can be seen from the above that in its preferred embodiments at least, the present invention provides an improved means for conveying status information relating to, e.g., the underlying status or condition of an electronic device, to a user of an electronic device. This is achieved by using a single icon that can simultaneously convey information about multiple status conditions or factors. In preferred embodiments, a human face is used as the icon, as this image is particularly suited to conveying plural varying and variable pieces of information to a user simultaneously.

1-43. (canceled)

44. A method of providing status information to a user of an electronic device, the method comprising:
displaying on a display of the electronic device an icon representing a status of a plurality of factors relating to an operation or condition of the device.

45. The method of claim 44, wherein the icon is used to display and represent the status of plural factors relating to the operation of at least one of the group consisting of a multi-modal and a speech-enabled user interface of the electronic device.

46. The method of claim 44, wherein at least one of the size and resolution of the icon can be varied in use.

47. The method of claim 44, wherein the icon conveys a range of values or status condition levels for at least one of the factors that it relates to.

48. The method of claim 44, wherein the icon conveys an acknowledgement of a user's audible command.

49. The method of claim 44, further comprising varying the icon to provide an indication of whether a user's spoken word or words to the device have been determined as being likely to be part of a recognizable sentence or command.

50. The method of claim 44, further comprising displaying the icon as a continuous sequence of images that are rendered in real-time in response to determined status conditions of the device.

51. A method of providing a speech-enabled interface for an electronic device, the method comprising:
determining a measure of whether a spoken word or words of a user are likely to be part of a recognizable sentence or command; and
displaying on a display of the electronic device an icon acknowledging that the user's spoken word or words has been recognizable on a basis of the determined measure.

52. A system for providing a user interface for an electronic device, comprising:
a processor for displaying on a display of the electronic device an icon representing a status of a plurality of factors relating to an operation or condition of the device.

53. The system of claim 52, wherein the icon displays and represents the status of the plurality of factors relating to the operation of at least one of the group consisting of a multi-modal and speech-enabled user interface of the device.

54. The system of claim 52, wherein at least one of a size and a resolution of the icon is modifiable for the user.

55. The system of claim 52, wherein the icon conveys a range of values or status condition levels for at least one of the factors that it relates to.

56. The system of claim 52, wherein the icon conveys an acknowledgement of a user's spoken audible commands.

57. The system of claim 52, further comprising a processor for varying the icon to provide an indication of whether the user's spoken word or words to the device have been determined as being likely to be part of a recognizable sentence or command.

58. The system of claim 52, further comprising a processor for displaying the icon as a continuous sequence of images that are rendered in real-time in response to determined status conditions of the device.

59. A system for providing a speech-enabled interface for an electronic device, the system comprising:
a processor for determining a measure of whether a spoken word or words of a user are likely to be part of a recognizable sentence or command; and
a processor for displaying on a display of the electronic device an icon acknowledging that the user's word or words has been recognized on the basis of the determined measure.

60. An electronic device, comprising:
a speech-enabled user interface, whereby a user may speak commands to operate the device;
a display;
a processor for determining or for receiving a measure of whether a spoken word or words of a user are likely to be part of a recognizable sentence or command; and
a processor for displaying on the display of the electronic device an icon acknowledging that the user's word or words has been recognized on the basis of the determined measure.

61. A computer program element comprising computer software code portions for performing the method of claim 44 when run on a data processing means.

62. A computer program element comprising computer software code portions for performing the method of claim 51 when run on a data processing means.

63. A system for providing a user interface for an electronic device, comprising:
means for displaying on a display of the electronic device an icon representing a status of a plurality of factors relating to an operation or condition of the device.

64. The system of claim 63, wherein the icon displays and represents the status of the plurality of factors relating to the operation of at least one of the group consisting of a multi-modal and speech-enabled user interface of the device.

65. The system of claim 63, wherein at least one of a size and a resolution of the icon is modifiable for the user.

66. The system of claim 63, wherein the icon conveys a range of values or status condition levels for at least one of the factors that it relates to.

67. The system of claim 63, wherein the icon conveys an acknowledgement of a user's spoken audible commands.

68. The system of claim 63, further comprising means for varying the icon to provide an indication of whether the user's spoken word or words to the device have been determined as being likely to be part of a recognizable sentence or command.

69. The system of claim 63, further comprising means for displaying the icon as a continuous sequence of images that are rendered in real-time in response to determined status conditions of the device.

70. A system for providing a speech-enabled interface for an electronic device, the system comprising:
means for determining a measure of whether a spoken word or words of a user are likely to be part of a recognizable sentence or command; and
means for displaying on a display of the electronic device an icon acknowledging that the user's word or words has been recognized on the basis of the determined measure.
